(19) United States
(12) Patent Application Publication
(10) Pub. No.: US 2014/0358575 A1
(43) Pub. Date: Dec. 4, 2014

(54) VITALITY PROGRAM FOR PARTICIPANT WELLNESS

(71) Applicant: Kimberly-Clark Worldwide, Inc., Neenah, WI (US)

(72) Inventors: Stephanie M. Martin, Johns Creek, GA (US); Bruce S. Williamson, Alpharetta, GA (US); Clarice M. Theisen, Alpharetta, GA (US); Jennifer M. Kaminski, Roswell, GA (US)

(73) Assignee: Kimberly-Clark Worldwide, Inc., Neenah, WI (US)

(21) Appl. No.: 14/278,021

(22) Filed: May 15, 2014

Related U.S. Application Data
(60) Provisional application No. 61/828,755, filed on May 30, 2013.

(51) Int. Cl. G06F 19/00

(52) U.S. Cl. CPC G06F 19/3481
USPC 705/2

(57) ABSTRACT

There is provided a method for maintaining, improving or reducing the decline of vitality among participants, having the steps of establishing a normal state for each participant using non-clinical baseline capacity measures, recommending non-clinical body, mind and spirit activities for the participant, practicing the activities by the participant, monitoring progress and providing regular feedback. This will result in vitality in at least one area being maintained, improved or reduced in decline.

This application claims priority from U.S. provisional patent application 61/828,755 filed on May 30, 2013.

This disclosure is concerned with the need for maintaining, improving or reducing the decline of vitality among participant.

Particular concern is directed to those preferring to live in an assisted living facility or to “age in place” by living substantially independently in an apartment or home. In addition to the benefit of reducing preventable illnesses as a method of promoting hygiene and/or wellness, methods such as this are expected to decrease pain and suffering, reduce costs by proactively reducing preventable occurrences versus treatment of preventables, and result in increased engagement, satisfaction and good-will within the participant's sphere of interaction including and/or among family, friends and medical professionals.

There is a need for a program, system or method that will help participants maintain, improve or slow the decline in vitality.

### SUMMARY

This program of vitality can involve coaching, assessment, measurement, goal setting, activities, rewards and monitoring to improve participant vitality. This is accomplished by adoption and adherence to new wellness behaviors and is supported by an engagement and interaction system that drives involvement.

In its broadest embodiment the program is a method for maintaining, improving or reducing the decline of vitality among participants, having the steps of establishing a normal state for each participant using non-clinical baseline capacity measures, recommending non-clinical body, mind and spirit activities for the participant, practicing the activities by the participant, monitoring progress and providing regular feedback. This will result in vitality in at least one area being maintained, improved or reduced in decline.

### DETAILED DESCRIPTION

It should be noted that, when employed in the present disclosure, the terms “comprises”, “comprising” and other derivatives from the root term “comprise” are intended to be open-ended terms that specify the presence of any stated features, elements, integers, steps, or components, and are not intended to preclude the presence or addition of one or more other features, elements, integers, steps, components, or groups thereof.

“Vitality” is meant to describe a state of physical vigor, capacity, energy level, animation, liveliness, stamina and the like, and/or having intellectual curiosity, fervor, exuberance, robustness or venturesomeness. It is generally the capacity to live, grow, or develop. A lack of vitality could be characterized by physical decline, apathy, lethargy and/or discouragement, frailty and sarcopenia. In its simplest terms, vitality may be thought of as the reverse or inverse of frailty and, like frailty, is not defined as a yes or no proposition but on a sliding scale from high to low.

Generally speaking, the vitality program seeks to move people away from “frailty” and toward better health. Frailty is a clinical term used to talk about aspects of aging like weight loss, slowness, weakness, etc. There are a number of definitions commonly in use for frailty although there is no commonly accepted, universal definition. The Cardiovascular Health Study (CHS) index suggest that frailty requires three or more of the following five factors to be present: unintentional weight loss, self-reported reduced energy level, reduced grip strength, slow walking speed and low level of physical activity. Frailty as defined by the CHS index has been found to be associated with an increased rate of falls, hospitalization, disability and death. An alternative measure of frailty is according to the Study of Osteoporotic Fractures (SOF) index. The SOF index uses only three factors; weight loss, the ability to rise five times from a seated position without using the patient's arms (rise and go test), and reduced energy level. These two indices have been found in studies to yield very similar results in terms of predictive ability, yet the SOF index procedures are simpler and easier to discern.

One useful frailty scale is based on a Canadian study on Health and Aging (2008) and is provided by Dalhousie University. This scale provides the following levels of frailty:
1. Very fit—People who are robust, active, energetic and motivated. These people commonly engage in exercise regularly. They are among the fittest for their age.
2. Well—People who have no active disease symptoms but are less fit than category 1. They exercise often or are very active occasionally, e.g. seasonally.
3. Managing well—People whose medical problems are well controlled, but are not regularly active beyond routine walking.
4. Vulnerable—While not dependent on others for daily help, symptoms often limit activities. A common complaint is being “slowed up” and or beng tired during the day.
5. Mildly frail—these people often have more evident slowing and need help in high order instrumental acts of daily living (IADLs), e.g. finances, transportation, heavy housework, medications. Typically, mild frailty progressively impairs shopping and walking outside alone, meal preparation and housework.
6. Moderately frail—people need help with all outside activities and with keeping house. Inside, they often have problems with stairs and need help with bathing and might need minimal assistance (cuing, standby) with dressing.
7. Severely frail—completely dependent for personal care, from whatever cause (physical or cognitive). Even so, they seem stable and not at high risk of dying (within 6 months).
8. Very severely frail—Completely dependent and approaching the end of life. Typically they could not recover from even a minor illness.
9. Terminally ill—Approaching the end of life. This category applies to people with a life expectancy of less than 6 months, who are not otherwise evidently frail.

Sarcopenia is characterized by a lower skeletal muscle quantity, higher fat accumulation in the muscle, lower muscle strength, and lower physical performance. The most commonly used, low cost and accessible methods to assess skeletal muscle mass include dual energy X-ray absorptiometry (DEXA), anthropometry and bioelectrical impedance analysis (BIA). Magnetic resonance imaging (MRI), computerized tomography (CT) and creatinine excretion are the most specific standards for assessing muscle mass or cross-sectional muscle area. Other available measures include peripheral quantitative computerized tomography (pQCT), ultrasound and neutron activation. Skeletal muscle strength is another important component for the assessment of sarcopenia and muscle quality. Several methods are available for the measurement of muscle strength and include simple dynamometers to measure isometric strength and the most complex isokinetic strength measures of power and torque. Standardized physical performance measures complement the measures of muscle mass for the assessment of sarcopenia. At least one organization, The European Working Group on Sarcopenia in Older People (EWGSOP) developed a practical clinical definition and diagnostic criteria for age-related sarcopenia. EWGSOP recommends using the presence of low muscle mass (mid-arm muscle circumference) plus either low muscle strength (hand grip) or low physical performance (time to walk 4 meters). Sarcopenic participants in one study were found to be over three times more likely to fall during a follow-up period of two years relative to non-sarcopenic individuals, regardless of age, gender and other confounding factors. Another study correlated low mid-arm muscle circumference to a higher risk of death.

Disclosed herein is a three-pronged program and method designed to address physical, mental, and spiritual health in order to take care of the entire person and not just one dimension. The program is based on a number of scientific studies about the benefits of staying mentally, physically, and spiritually engaged to maintain a healthy life as one ages. There are provided a combination of specific activities for participants to improve health and reduce frailty.

This program can provide a system of simple daily activities that, when undertaken regularly, will help participants maintain or increase their sense of vitality and purpose. It can provide a means by which participants will see how small steps add up to improve wellbeing, provide “credit” for daily activities they enjoy, allow them to receive coaching and encouragement to weave healthy behaviors into their day and to learn simple habits that will help better protect them from illness.

Implicit in this disclosure is a belief that vitality can be sustained and possibly improved via the accumulated benefit of regular, small steps. We believe that participants can sustain their own vitality when provided knowledge, support and encouragement. This program and system give participants “credit” or “points” for vitality sustaining behaviors, along with encouragement and evidence will start a cascade of health affirming activity. Improving participant vitality can result in more participants able to age in place as well as fewer hospitalizations and re-hospitalizations, fewer falls with injuries and reduced drug costs.

The disclosed program and system is a behavior modification platform that sustains and or improves participant vitality by providing feedback for small positive actions woven into everyday life, and linking those actions to positive outcomes. It involves and motivates the participant and where applicable, the assisted living community to act together to improve vitality by leveraging positive psychology and is embraced by the participant, his family and aides. This helps service providers by driving down costs associated with participant illnesses and driving up preference for the service and facility.

While it is believed that this program would be useful to participants of all ages within the constraints of any disabilities they may have, it is primarily meant to address those who are elderly and/or in the frailty classifications of 3-6 and perhaps 7 (on a case by case basis) based on the frailty scale provided by Dalhousie University above. “Elderly” generally refers to those who are age 65 and older, though this is a definition that is not universal or rigid. A person of less than 65 years, e.g. 60, may be referred to as an elder as well. This program is may also be directed toward semi-independent participants living in an assisted living facility who receive activities of daily living (ADL) assistance from paid caregivers like personal care assistants (PCAs). Action may be taken by the participant himself with the PCA acting as vitality coach, motivator and guide, encouraging him to set goals and achieve targets in support of sustaining or improving his vitality in at least one critical area.

The program focusses on three critical areas for participant vitality; improvement, maintenance or slowing decline in the body, mind and/or spirit.

Body: Undertaking regular, gentle, condition-appropriate physical activity will help participants sustain their capabilities. It's believed that participants want to maintain or improve their personal “normal” and stave off deterioration. Appropriate activities combined with healthy behaviors will support ongoing wellness and minimizing preventable illness will play an important role in maintaining health. The goal of the “body” portion of the vitality program is to track and encourage physical activity and healthy behaviors, not to prescribe them.

Mind: An engaged, active mind plays a critical role in sustained vitality regardless of physical condition. Crossword puzzles, Sudoku, brain teasers, listening to music, playing chess, knitting, dancing, journaling have all been proven to improve health and brain function. It's believed that many participants already enjoy an activity like this but may not know just how good it is for them, both mentally and physically.

Spirit: It's believed that a resilient spirit is a key underpinning of a vital body and mind and that strengthening mind and body health has a positive effect on the human spirit, and vice versa. Studies increasingly suggest the positive effect of spiritual activities such as prayer, meditation, and reflection. Maintaining connectedness with others buoys the spirit and it is desired to foster interactions, connectedness and reciprocity and nurture the spirit by creating a sense of fun, excitement, and education around activities that promote a body, mind, spirit balance.

In its broadest embodiment (A) the program involves the steps of:
1. Establishing a starting vitality state for each participant using non-clinical baseline capacity measures.
2. Recommending non-clinical body, mind and spirit activities for the participant.
3. Practicing (or performing) the activities by the participant.
4. Monitoring compliance with the recommendations.
5. Providing feedback.

In another embodiment (B) the program can include:

1. Establishing “My Normal” (the starting state of vitality) for each participant using non-clinical baseline capacity measures.
2. Developing participant defined vitality goals.
3. Recommending non-clinical body, mind and spirit activities for the participant.
4. Monitoring compliance with the recommendations and the progress made toward the goals established by the participant.
5. Providing regular feedback, linking the monitored compliance with the goals established by the participant.
6. Recommending, if necessary, new activities for the participant based on the progress measured.
7. Repeating steps 4, 5 and 6 as desired.

In still another embodiment (C) the program can include:
1. Establishing “My Normal” (the starting state of vitality) for each participant using non-clinical baseline capacity measures.
2. Developing participant defined vitality goals.
3. Recommending non-clinical body, mind and spirit activities for the participant.
4. Monitoring compliance with the recommendations and the progress made toward the goals established by the participant.
5. Providing regular feedback, linking the monitored compliance with the goals established by the participant as well as considering the speed at which the participant is progressing toward the goals established by the participant.
6. Recommending, if necessary, new activities for the participant based on the progress measured.
7. Repeating steps 4, 5 and 6 as desired.

In still another embodiment (D) the program can include:
1. Establishing “My Normal” (the starting state of vitality) for each participant using non-clinical baseline capacity measures.
2. Providing goals developed by a health care or physical fitness expert or generally accepted in the field of elder health, appropriate for the state of vitality of the participant.
3. Recommending non-clinical body, mind and spirit activities for the participant.
4. Monitoring compliance with the recommendations and the progress made toward the goals.
5. Providing regular feedback, linking the monitored compliance with the goals.
6. Recommending, if necessary, new activities for the participant based on the progress measured.
7. Repeating steps 4, 5 and 6 as desired.

In still another embodiment (E) the program can include:
1. Establishing “My Normal” (the starting state of vitality) for each participant using non-clinical baseline capacity measures.
2. Developing participant defined vitality goals.
3. Recommending non-clinical body, mind and spirit activities for the participant.
4. One on one coaching for support, encouragement, engagement.
5. Integration of regular body, mind and spirit non-clinical activities and interventions into the daily life of each participant, in keeping with the participant's level of interest and desire for participation.
6. Engaging a support team for encouragement and reinforcement.
7. Monitoring progress and providing regular feedback, linking activities to outcomes.
8. Refreshing the program regularly to maintain interest and involvement.
   Each of the above elements of the program will be discussed in greater detail below:

The establishment of non-clinical baseline data can include key demographic information regarding age, marital status, and family members (children, grandchildren), baseline health and vitality data, notations to eliminate specific physical activities the participant should avoid, and self-segmentation, i.e. the preferred approach for each participant to be approached and rewarded. This information may be obtained through an interview with the participant, his family members and friends, and his medical care givers. The CHS Index, SOF Index, EWGSOP tests or alternatives to or combinations thereof may be used to help establish the starting physical abilities data.

The participant defined vitality goals can include, as an example, the participant's desired strength and flexibility goals (body), the desire to master a new hobby or learn a language (mind) and the desire to volunteer at a food bank (spirit). These goals are highly individualized and require discussion and exploration with the participant of the possibilities available in the participant's location, keeping in mind any limitations that may frustrate reaching the goals. Desirably each participant will have 1 to 3 goals in each category; body, mind and spirit.

Alternatively, goals may be established by a healthcare provider or expert in physical fitness. Goals may also be established by review of literature, respected in the art of defining fitness and abilities of subjects similar to the participant. Large scale studies, for example, of cohorts comprised of members in similar circumstances to the participant may be useful in establishing realistic goals. The assistance of the participant's family, friends and significant others (the support team) may also be helpful in establishing goals for the participant.

After the baseline data has been gathered, the recommendations for body, mind and spirit activities for each participant can be developed. These may include:

Body:

For a vital body, activities that encourage the participant to “exercise”, “protect” (himself) and “nourish” (his body) can be provided as part of the program.

“Exercise” can involve strength and flexibility exercises, and activities directed toward improving balance and posture.

“Protect” can involve educating the participant about activities that reduce his exposure to germs such as proper hand washing and the use of products that help reduce germs in his environment.

“Nourish” can include information about hydration and proper nutrition, within the constraints of any medically required dietary restrictions.

Mind:

For a vital mind, activities that encourage the participant to “play”, “enjoy” and “expand” (their mind) can be provided as part of the program.

“Play” can involve engagement in board games, card games, crossword puzzles and other word search games, sudoku, number games and the like.

“Enjoy” can involve the participant in music (listening or playing), art, cooking, crafts (e.g. woodworking, painting, drawing, knitting etc.) and other hobbies.

“Expand” can include reading newspapers, books and the like, writing in a journal, a letter etc., and learning a new skill, language or information, such as through an adult education course at a local college. “Expand” can also mean increasing the difficulty or frequency of an already performed action.

Spirit:

For a vital spirit, activities that encourage the participant to “reflect”, “connect” and “contribute” can be provided as part of the program.

“Reflect” can involve prayer, meditation, and inspirational reading. This can also include quiet contemplation, practicing breathing exercises or yoga and listening to inspirational recitals.

“Connect” encourages socialization and interaction with others through phone calls, writing a letter, internet interaction, or face to face meetings, e.g. over coffee.

“Contribute” includes volunteering, donating and sharing wisdom with others. This may be done through affiliation groups like religious, cultural or ethnic organizations, community groups, schools, hospitals and the like.

While a listing of activities is included above, the actual recommendations for each participant must be developed with an understanding of the participant's state of vitality and the goals. It is also desired that the recommendations that are developed go beyond merely those suggested by the participant since expansion of one's activities is also desired to increase vitality. An participant who expresses an interest in a particular area; e.g. baseball, may be recommended to try fantasy football, for example. The personality of the participant can be used as a guide to finding alternative activities that may appeal to the participant but which he has not tried.

Regular one on one coaching is important because, especially for “body” activities, the proper technique to avoid injury or excessive use or wear is desired. It is believed that the “mind” and “spirit” activities have less potential for overstress, but nevertheless, coaching is desired to ensure that the participant does not become frustrated with the activity, the program or his progress.

Coaching may be on an everyday schedule or may be less frequent. Coaching may also be done in-person or via technology such as smart phones, tablet type devices (e.g. i-pad) or through a computer terminal through the participant is monitored and encouraged.

Interaction of coaches to compare notes, with appropriate protection of confidentiality, is also desirable. The coaches should discuss the progress of the participant with the participant's support team, healthcare providers, experts in physical fitness and training, and others who may be able to offer assistance.

The integration of regular body, mind and spirit non-clinical activities and interventions into the life of each participant, in keeping with the participant's level of interest and desire for participation is a key part of the program. Without the participant's carrying out the recommended activities, the improvement in vitality or slowing of the decline in vitality will not occur. It is desired that at least some activities occur on each day so that the participant remains connected to the program and in order to reap the benefits of the program.

The use of a support team for encouragement and reinforcement is desired. This can be combined with coaching so that the coach provides positive feedback for the participant and encourages him to continue to do the recommended activities or substitutes that the participant may prefer. Alternatively, the support and encouragement may come from a medical caregiver or from a family member or friend.

Monitoring the progress and providing regular feedback is important so that the activities become linked to the outcomes in the participant's mind. The activities that each participant participates in are desirably recorded, desirably on a daily basis, so that progress he is making toward his self-defined goals may be seen. This can be done by the participant or an assistant (e.g. the coach) entering the daily data through a digital interface (e.g. a computer, smart phone or tablet device), or, less optimally, on a hard copy form. While the act of recording alone provides reinforcement, it is desired that the information entered will be used by the coach and support team to provide feedback and let the participant know how he is progressing. It is desired that a clear link be made between the activities and improvements in vitality in the participant's mind.

Feedback to the participant is important as it allows the participant to understand how he is progressing toward his goal. Feedback may be qualitative or quantitative. Qualitative feedback may consist of encouragement regarding the amount of progress the participant has made thus far towards his goal. Quantitative feedback may be based on a scale, e.g. 0-5, regarding the participant's form while performing an activity, the number of repetitions or amount of weight involved (if a physical activity), of the participant's attitude while performing the activity. A reward system may be included in the feedback to the participant.

A reward system may involve the use of credits or points rewarded to the participant based on the compliance with the recommendations and/or on the practicing of the activities. These credits could be awarded based on the performing of the activities, the frequency of performance, the quality and quantity of the performance as desired. Credits could be accumulated toward redemption for various prizes as desired.

It should be clear from this listing of program steps that some may be combined and others even deleted without departing too far from the spirit of this disclosure. For example, establishing a baseline vitality level and establishing goals may be combined in, e.g., one interview with the participant. Likewise, coaching, recommending activities, engaging a support team and monitoring compliance (or sub-groupings thereof) could be combined so that the interactions with the participant are more efficient. In its broadest embodiment the program is a method for maintaining, improving or reducing the decline of vitality among participants, having the steps of establishing a normal state for each participant using non-clinical baseline capacity measures, recommending non-clinical body, mind and spirit activities for the participant, practicing the activities by the participant, monitoring progress and providing regular feedback. This will result in vitality in at least one area being maintained, improved or reduced in decline.

Although the present disclosure has been described with reference to various embodiments, those skilled in the art will recognize that changes may be made in form and detail without departing from the spirit and scope of the disclosure. As such, it is intended that the foregoing detailed description be regarded as illustrative rather than limiting and that it is the appended claims, including all equivalents thereof, which are intended to define the scope of the disclosure.

What is claimed is:

1. A method for maintaining, improving or reducing the decline of vitality among participants, comprising the steps of:
a. establishing a starting vitality state for each participant using non-clinical baseline capacity measures,
b. recommending non-clinical body, mind and spirit activities for the participant,
c. practicing the activities by the participant,
d. monitoring compliance with the recommendations,
e. providing feedback,
wherein vitality in at least one area is maintained, improved or reduced in decline.

2. The method according to claim 1, further comprising the step of developing vitality goals that are participant defined, provided by a healthcare or fitness professional, or developed from literature sources.

3. The method according to claim 1, further comprising the step of recommending, if necessary, new activities for the participant based on the progress measured.

4. The method according to claim 1, further comprising the step of coaching for support, encouragement, engagement.

5. The method according to claim 1, further comprising the step of engaging a support team for encouragement and reinforcement.

6. The method according to claim 1, further comprising the step of refreshing the program to maintain interest and involvement.

7. The method according to claim 1 wherein the participant's body vitality is maintained, improved reduced in decline.

8. The method according to claim 1 wherein the participant's mind vitality is maintained, improved reduced in decline.

9. The method according to claim 1 wherein the participant's spirit vitality is maintained, improved reduced in decline.

10. The method of claim 1 wherein the feedback includes credits or points rewarded to the participant based on compliance with the recommendations and/or on the practicing of the activities.

11. The method of claim 10 wherein the credits or points are awarded based on the practicing of the activities including frequency of practicing, quality and quantity of the practicing of the activities.

12. The method of claim 10 wherein said credits or points are accumulated toward redemption for prizes.

13. A method for maintaining, improving or reducing the decline of vitality among participant, comprising the steps of:
establishing a normal state for each participant using non-clinical baseline capacity measures,
developing vitality goals,
recommending non-clinical body, mind and spirit activities for the participant, one on one coaching for support, encouragement, engagement,
a. integrating regular body, mind and spirit non-clinical activities and interventions into the daily life of each participant, in keeping with the participant's level of interest and desire for participation,
b. engaging a support team for encouragement and reinforcement,
c. monitoring progress and providing regular feedback, linking activities to outcomes, and;
d. refreshing the program regularly to maintain interest and involvement,
wherein vitality in at least one critical area is maintained, improved or reduced in decline.
